(19) United States
(12) Patent Application Publication
(10) Pub. No.: US 2016/0244339 A1
(43) Pub. Date: Aug. 25, 2016

(54) MEMBRANE TREATMENT/SEPARATION PLANT AND CONTROL SYSTEM

(71) Applicant: HATCH LTD., Mississauga (CA)

(72) Inventors: Luke Andrew REEVES, Scarborough (AU); Mark Alistair PEACOCK, Gwelup (AU)

(21) Appl. No.: 15/071,951

(22) Filed: Mar. 16, 2016

Related U.S. Application Data
(63) Continuation of application No. 13/816,859, filed on Feb. 13, 2013, now abandoned.

(51) Int. Cl. C02F 1/00; B01D 65/02; B01D 61/22; B01D 61/12; B01D 61/14; C02F 1/44; B01D 61/02

(52) U.S. Cl. CPC C02F 1/008; C02F 1/004; C02F 1/441; C02F 1/442; C02F 1/444; B01D 65/02; C02F 1/006; B01D 61/022; B01D 61/12; B01D 61/142; B01D 61/22; B01D 2321/20; C02F 2101/10

(57) ABSTRACT

A membrane treatment plant having at least two stages (53), (69), (75) arranged serially is disclosed. Each stage (53), (69), (75) comprises at least four membrane units (55) arranged in parallel, with each membrane unit (55) having an inlet (57), a feed/concentrate outlet (59) and a permeate outlet (61). Each stage (53), (69), (75) has a common inlet header (51), (67), or (73) and a common outlet header (65), (71) or (77), with the common outlet header (65) (71) of an upstream stage connecting to the common inlet header (67) (73) respectively of an immediately downstream stage. Each membrane unit (55) has an inlet flow control valve (93) connecting between its inlet (57) and the common inlet header of the stage in which it is located, and an outlet flow control valve (63) connecting between its outlet (59) and the common outlet header stage in which it is located. The inlet flow control valve (57) and outlet flow control valve (63) are operable to isolate the membrane unit (55) from its common inlet header and common outlet header to allow cleaning of said membrane unit to take place without disrupting operation of the remaining membrane treatment plant. A control system for the membrane treatment plant is also disclosed.

### FIELD

The present subject matter relates to water treatment plants, and in particular to waste water treatment plants. It has particular application in cross flow filtration or membrane treatment plants including those for treatment of process fluids, waste water and desalination of sea water.

### BACKGROUND

The following discussion of the background is intended to facilitate an understanding of the present subject matter. It should be appreciated that the discussion is not an acknowledgement or admission that any of the material referred to was part of the prior art in any jurisdiction, as at the priority date of the application.

Filtration using media to filter suspended solids from solution has been accomplished in the past using various techniques. Scaling up from laboratory to industrial filtration presents its own problems, and membrane filter technology would be the main technique employed in industrial scale separation technology. Membrane filter technology is employed in microfiltration, ultrafiltration, nanofiltration and reverse osmosis. Filtration modules may comprise spiral wound membrane elements, tubular membrane elements, and hollow fibre membrane elements.

Reverse osmosis has been described as a technique for recovering purified water from a solution containing dissolved salts. Indeed reverse osmosis forms the basis for desalination plants used around the world to provide potable water. Reverse osmosis is a process whereby a membrane acts as a molecular filter to remove up to >99% of dissolved solids from water. Reverse osmosis has been considered as a candidate for treating waste waters from mining and industrial processes; however, considerable problems arise where solids are present in the feed water, causing fouling of the reverse osmosis filters. This leads to degradation of performance and consequent maintenance down-time, and depending on the nature of the contaminant, may lead to permanent damage of the reverse osmosis filters.

In reverse osmosis, the flow rate of water through the membrane is directly proportional to its area, and the driving pressure over and above the osmotic pressure of the feed solution. Reverse osmosis filter elements have been developed so that there is the greatest possible area of membrane in a given volume. This has led to the development of spiral wound membrane elements, such as that illustrated in FIG. 1. The element is in the form of a membrane module which is in the form of a canister 11 having a central conduit 13 for discharge of permeate product, surrounded in near coaxial arrangement by a feed port 15 at one end and a concentrate outlet port 17 at the other end. The element has a casing which is typically a fiberglass outer wrap. The reverse osmosis membranes 19 are characterized by a thin dense surface layer 21 on one side whilst the other side of the membrane film, made from a combination of a polyester support sheet and a polysulfone OF material, acts as a porous support layer 23.

The feed/concentrate flow path through leaves of opposed membranes 19 is kept turbulent by means of a spacer sheet 25 between the dense surfaces layers 21 of the membranes 19. A permeate carrier fabric 27 is used next to the membrane 19 support layer 23 to convey permeate in an inward spiral flow path to the central conduit 13 at the centre of the canister 11, for discharge therefrom. Feed/concentrate flow is axial along each spacer sheet 25 in the casing.

An end cap 29 with a central product conduit 31 and radial arms 33 provides structural support to prevent telescoping of the spiral leaves. The product conduit 31 of the end cap 29 sealingly connects with the central conduit 13, while space between the radial arms 33 provides passage for the feed/concentrate flow. While radial arms 33 are shown, a solid disk with circular or other shaped apertures could be employed to equal effect to provide structural support and passage for the feed/concentrate flow.

The elements are typically 2% inches, 4 inches, 8 inches, 16 inches or 18 inches in diameter (depending on the unit) and one meter long. From two or three up to seven, but typically six of the canisters are arranged serially in a membrane housing to form a typical reverse osmosis stage, and additional canisters in membrane housings can be provided in parallel with these to achieve a desired processing rate to form a membrane unit. An o-ring 35 located in an annular recess 37 in the outer periphery of the end cap 29, provides a seal around the end cap 29 to seal between the canisters and the membrane housing to prevent feed/concentrate bypassing the canisters.

As discussed above, fouling presents a problem in reverse osmosis. All aspects of fouling involve the trapping of some type of material within the reverse osmosis device itself or on the surface of the membrane. Fouling can occur due to but not limited to membrane scaling, scaling by precipitates, device plugging, colloidal fouling or biological fouling.

The inventors have realized that the traditional approach for multi stage reverse osmosis processing of waters of configuring the stages in a serial manner, gives rise to inefficiencies. In the traditional approach, each stage may comprise a number of membrane units operating in parallel, with each membrane unit having a predetermined number of membrane housings, the predetermined number being determined by hydraulics of the system, but the configuration traditionally adopted has been to have a single membrane unit in a first stage feed to a single membrane unit in a second stage, and feed to a single membrane unit in a third stage, (if a third stage is utilized), and so on. As a consequence, when a membrane unit in one of the stages is fouled and requires cleaning, the entire train must go off-line for the duration of the cleaning.

The inventors have determined an alternative novel configuration of interconnection of stages that overcomes some difficulties inherent with the traditional approach. In addition the inventors have devised a cleaning regime and a control system for a membrane plant that leads to improved efficiencies in operation of membrane plants, whether they are used for reverse osmosis, nanofiltration, or ultrafiltration.

### SUMMARY

In accordance with one aspect of the present subject matter there is provided a membrane treatment plant having at least two stages arranged serially, each stage comprising at least four membrane units, each membrane unit having an inlet, a feed/concentrate outlet and a permeate outlet;

each of said stages having a common inlet header and a common outlet header, with the common outlet header of an upstream stage connecting to the common inlet header of an immediately downstream stage;

each membrane unit having an inlet flow control valve connecting between said inlet and said common inlet header, and an outlet flow control valve connecting between the feed/concentrate outlet and said common outlet header, said inlet flow control valve and said outlet flow control valve being operable to isolate said membrane unit from said common inlet header and said common outlet header to allow cleaning of said membrane unit to take place without disrupting operation of the remaining membrane treatment plant.

In some embodiments there are up to six membrane units in each stage. For example, there may be five membrane units in each stage.

The common inlet header and the common outlet header may take the form of a manifold or may be as simple as inter-connecting pipework leading to inlet flow control valves and outlet flow control valves respectively. The membrane units may comprise housings which contain one or more spiral wound membrane elements, or may comprise other types of membrane elements as are known in the art. The treatment plant may be a reverse osmosis plant, a nanofiltration plant, an ultra filtration plant (i.e. larger than nano-sized particles and molecules), or a graduated membrane treatment plant, such as that described in the applicants' co-pending patent application entitled “Graduated Membrane Water Treatment Plant”, the contents of which are incorporated herein by cross reference.

Each membrane unit may have a cleaning circuit inlet valve connecting to the inlet and a cleaning circuit outlet valve connecting to the feed/concentrate outlet, to allow in-circuit cleaning of the membrane unit to take place when the membrane unit is isolated from the common inlet header and the common outlet header. In practice, the cleaning circuit inlet valve and cleaning circuit outlet valve can be connected to a recirculating pump to supply cleaning fluid and rinse fluid to the membrane unit.

In some embodiments, the membrane treatment plant has a cleaning inlet common header and a cleaning outlet common header connecting to the cleaning circuit inlet valve and cleaning circuit outlet valve of each membrane unit in the membrane treatment plant, and the cleaning inlet common header and the cleaning outlet common header are connected to a recirculating pump to supply cleaning fluid and rinse fluid to the membrane unit.

Alternatively each stage in the membrane treatment plant may have a cleaning inlet common header and a cleaning outlet common header connecting to the cleaning circuit inlet valve and cleaning circuit outlet valve of each membrane unit in the stage, and each cleaning inlet common header and the cleaning outlet common header of each stage are connected to a recirculating pump to supply cleaning fluid and rinse fluid to the membrane unit.

Each membrane unit may have a drain valve connected to the feed/concentrate outlet, and each membrane unit may have a permeate outlet flow control valve connected to the permeate outlet.

In some examples, the inlet flow control valve is a stop valve. A stop valve provides simple on/off control of liquor entering the membrane unit.

In some embodiments, the outlet flow control valve is a proportional valve. The proportional valve allows for flow control of feed/concentrate (fluid) leaving the membrane unit, and control of fluid pressure on the membrane within the membrane unit, in addition to being able to be shut-off to isolate the membrane unit from the common outlet header.

In some cases, the permeate outlet flow control valve is a proportional valve. The proportional valve allows for flow control of permeate leaving the membrane unit, and control of fluid pressure across the membrane within the membrane unit, in addition to being able to be shut-off to isolate the membrane unit from a permeate common outlet header. In operation, the setting of the permeate outlet flow control valve controls the flux rate through the feed/concentrate permeate barrier. The fluid is supplied to the membrane treatment plant at a pressure sufficient so that the permeate outlet flow control valves are not fully open.

In some examples, the inlet of each membrane unit has associated therewith an inlet flow measuring device for measuring volumetric flow into the inlet. This may be located on either side of the inlet flow control valve, but after the common inlet header, so as to be measuring flow into the membrane unit. Measurement of flow into the membrane unit allows an indication to be obtained regarding the degree of contamination or blockage of the membrane unit, indicating that cleaning may be required. As there are more than one membrane units located between the common inlet header and the common outlet header in any stage, any reduction in flow to one particular membrane unit could be indicative of the need to clean the membrane unit having the lower flow, assuming that the lower flow is not due to outlet flow control valve being operated to restrict the flow. Generally the outlet flow control valves for each membrane unit are adjusted to balance the flow rates through all membrane units of each stage in the plant, as measured by the flow measuring devices associated with each membrane unit.

In some embodiments, the permeate outlet of each membrane unit has associated therewith a permeate flow measuring device for measuring volumetric flow from the permeate outlet. This may be located on either side of the permeate outlet flow control valve, but before the permeate common outlet header, so as to be measuring flow of permeate from the membrane unit.

In some examples, the permeate outlet of each membrane unit has associated therewith a pressure measuring device for measuring pressure at the permeate outlet, before the permeate outlet control valve. In operation of a membrane unit, the permeate outlet flow control valve is used to restrict the flow of permeate, which raises the pressure. Any increase in pressure can be indicative of blockage or contamination in the membrane unit.

In some cases, the common inlet header has a pressure measuring device associated therewith, to measure fluid pressure in the common inlet header.

Preferably the common outlet header has a pressure measuring device associated therewith, to measure fluid pressure in the common outlet header. It will be understood that where a common outlet header connects to a downstream common inlet header of a subsequent stage, a common pressure measuring device will suffice.

In accordance with another aspect of the present subject matter there is provided a control system for controlling operation of a membrane treatment plant as described above, the control system controlling operation of inlet flow control valves and outlet flow control valves of a plurality of membrane units to take at least one membrane unit in any stage off-line for cleaning, and controlling cleaning circuit inlet valves and cleaning circuit outlet valves associated with the targeted the at least one membrane unit to feed cleaning solution to the targeted the at least one membrane unit.

In some embodiments, the control system controls operation of inlet flow control valves and outlet flow control valves of the plurality of membrane units to take at least one membrane unit in any stage off-line on a rotational basis for cleaning.

In some examples, the control system incorporates a manually initiated “clean now” function for any one or more of the plurality of membrane units to take at least one membrane unit in any stage off-line for cleaning.

In some cases, the control system monitors membrane resistance, by measuring flux rate for each membrane unit and storing current flux rate values, controlling a permeate outlet flow control valve for each membrane unit to achieve a desired flux rate, where a high membrane resistance indication is given if the permeate outlet flow control valve is from 85% to 90% open to fully open and the actual flux rate falls below 90% of the desired flux rate.

In some embodiments, the control system monitors membrane resistance, by measuring flux rate for each membrane unit and storing current flux rate values, controlling a permeate outlet flow control valve for each membrane unit to achieve a desired flux rate, where a high membrane resistance indication is given if the permeate outlet flow control valve is from 85% to 90% open to fully open and the actual flux rate falls below 85% of the desired flux rate.

In some examples, the control system monitors membrane resistance, by measuring flux rate for each membrane unit and storing current flux rate values, controlling a permeate outlet flow control valve for each membrane unit to achieve a desired flux rate, where a high membrane resistance indication is given if the permeate outlet flow control valve is from 85% to 90% open to fully open and the actual flux rate falls below 80% of the desired flux rate.

In some cases, the control system monitors membrane resistance, by measuring flux rate for each membrane unit and storing current flux rate values, controlling a permeate outlet flow control valve for each membrane unit to achieve a desired flux rate, where a high membrane resistance indication is given if the permeate outlet flow control valve is from 85% to 90% open to fully open and the actual flux rate falls below 75% of the desired flux rate.

In some embodiments, the control system monitors membrane resistance, by measuring flux rate for each membrane unit and storing current flux rate values, controlling a permeate outlet flow control valve for each membrane unit to achieve a desired flux rate, where a high membrane resistance indication is given if the permeate outlet flow control valve is from 85% to 90% open to fully open and the actual flux rate falls below 70% of the desired flux rate.

In addition to the above described arrangements, the control system may adjust the pressure of the inlet feed, to assist in meeting the desired flux rate. It is preferred that the permeate outlet control valve is maintained at no more than 90% open, providing some restriction in the permeate outlet, to provide back pressure in the permeate outlet to assist in minimizing membrane fouling while not leading to inefficiency by unnecessarily loading the pumps.

In one arrangement, the control system collates occurrences of high membrane resistance indication and uses this data to determine and implement a cleaning schedule for the membrane treatment plant. In another arrangement, a high membrane resistance indication may trigger an audible or visual alarm, or both, which can alert staff to the necessity to perform a “clean now” function on the membrane unit exhibiting excessive membrane resistance.

In some embodiments, the control system monitors flow balancing of the membrane units by measuring individual feed flow to each inlet of each membrane unit in each stage of membrane units, storing current feed flow values separately for each stage, controlling each outlet flow control valve associated with each membrane unit to balance feed flow to each inlet of each membrane unit in each stage, and issuing a high membrane plugging indication for a membrane unit if any of its outlet flow control valves is opened to 90% and the inlet flow value for that membrane unit drops to 20% below the inlet flow value for other membrane units in the same stage. In operation, flow balancing is achieved by operation of the outlet flow control valves for each membrane unit.

In some examples, the control system monitors flow balancing of the membrane units by measuring individual feed flow to each inlet of each membrane unit in each stage of membrane units, storing current feed flow values separately for each stage, controlling each outlet flow control valve associated with each membrane unit to balance feed flow to each inlet of each membrane unit in each stage, and issuing a high membrane plugging indication for a membrane unit if any of its outlet flow control valves is opened to 90% and the inlet flow value for that membrane unit drops to 25% below the inlet flow value for other membrane units in the same stage.

In some cases, the control system monitors flow balancing of the membrane units by measuring individual feed flow to each inlet of each membrane unit in each stage of membrane units, storing current feed flow values separately for each stage, controlling each outlet flow control valve associated with each membrane unit to balance feed flow to each inlet of each membrane unit in each stage, and issuing a high membrane plugging indication for a membrane unit if any of its outlet flow control valves is opened to 90% and the inlet flow value for that membrane unit drops to 30% below the inlet flow value for other membrane units in the same stage.

In some embodiments, the control system monitors flow balancing of the membrane units by measuring individual feed flow to each inlet of each membrane unit in each stage of membrane units, storing current feed flow values separately for each stage, controlling each outlet flow control valve associated with each membrane unit to balance feed flow to each inlet of each membrane unit in each stage, and issuing a high membrane plugging indication for a membrane unit if any of its outlet flow control valves is opened to 90% and the inlet flow value for that membrane unit drops to 35% below the inlet flow value for other membrane units in the same stage.

In one arrangement, the control system collates occurrences of high membrane plugging indication and uses this data to determine and implement a cleaning schedule for the membrane treatment plant. In another arrangement, a membrane plugging indication may trigger an audible or visual alarm, or both, which can alert staff of the necessity to perform a “clean now” function on the membrane unit exhibiting excessive membrane plugging.

In another arrangement, the membrane resistance indication and membrane plugging indication data are used together for the above purposes.

In some embodiments, the control system controls said membrane treatment plant by measuring individual feed flow for each inlet of each membrane unit in each stage of membrane units, measuring permeate flow and concentrate flow for each membrane unit, measuring inlet and outlet header pressures and permeate pressure for each membrane unit, and controlling outlet flow control valves associated with each membrane unit to balance feed flow to each inlet of each membrane unit in each stage.

### BRIEF DESCRIPTION OF THE DRAWINGS

FIG. 1 is an embodiment will now be described with reference to the following description of a nanofiltration plant with associated clean-in-place circuitry, as illustrated in the drawings in which:

FIG. 2 is a block schematic of a membrane plant according to the embodiment;

FIG. 3 is a further block schematic of the membrane plant of FIG. 2, showing three alternative configurations.

FIG. 4 is a schematic view of detail of a membrane unit within the membrane plant;

FIG. 5 is a block schematic of a membrane unit within the membrane plant, showing interconnected clean-in-place plant and equipment; and

FIG. 6 is a block schematic of a control system for the membrane plant.

### DETAILED DESCRIPTION

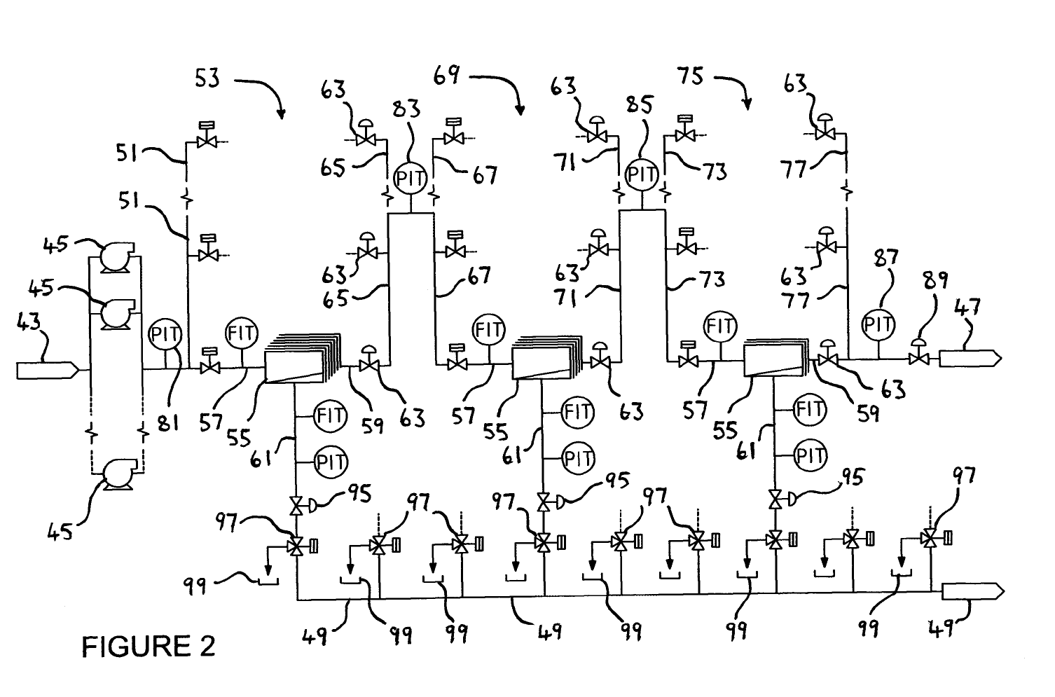

The nanofiltration plant, shown generally in FIG. 2 is designed to receive a feed stream 43 supplied under pressure by a train of pumps 45 arranged in parallel. The nanofiltration plant is designed to remove multivalent and complex ions to a concentrate stream 47 whilst allowing monovalent ions to pass through to a permeate stream 49.

The pumps 45 pump feed to a first stage inlet common header 51 for supply to a first stage 53 comprising a plurality of membrane units 55.

The membrane units each have a feed inlet 57, a feed/concentrate outlet 59, and a permeate outlet 61.

The feed/concentrate outlets 59 of the membrane units 55 of the first stage 53 each feed via a remotely actuable proportional control valve 63 to a first stage outlet common header 65 which is connected directly to a second stage inlet common header 67 for supply to a second stage 69 also comprising a plurality of membrane units 55, each with feed inlet 57, feed/concentrate outlet 59, and permeate outlet 61.

The feed/concentrate outlets 59 of the membrane units 55 of the second stage 69 each feed via a remotely actuable proportional control valve 63 to a second stage outlet common header 71 which is connected directly to a third stage inlet common header 73 for supply to a third stage 75 also comprising a plurality of membrane units 55, each having feed inlet 57, feed/concentrate outlet 59, and permeate outlet 61.

The feed/concentrate outlets 59 of the membrane units 55 of the third stage 75 each feed via a remotely actuable proportional control valve 63 to a third stage outlet common header 77 which discharges to the concentrate stream 47.

The permeate outlet 61 of all membrane units 55 of the first stage 53 the second stage 39 and the third stage 75 are, in use, delivered to the permeate stream 49.

A first pressure transducer 81 is provided to measure pressure in the first stage inlet common header 51. A second pressure transducer 83 is provided to measure pressure in the first stage outlet common header 65 and the second stage inlet common header 67. A third pressure transducer 85 is provided to measure pressure in the second stage outlet common header 71 and the third stage inlet common header 73. A fourth pressure transducer 87 is provided to measure pressure in the third stage outlet common header 77.

A remotely actuable proportional control valve 89 is provided to provide a controllable restriction in the flow to the concentrate stream 47, to maintain required feed/concentrate flow and hence overall volumetric recovery of permeate in the nanofiltration plant. The pumps 45 are controlled to provide the required plant pressure as measured by the first pressure transducer 81. The pressure transducers 81, 83, 85, and 87 provide pressure data to monitor the status of the membrane units, as will be understood from the discussion which follows.

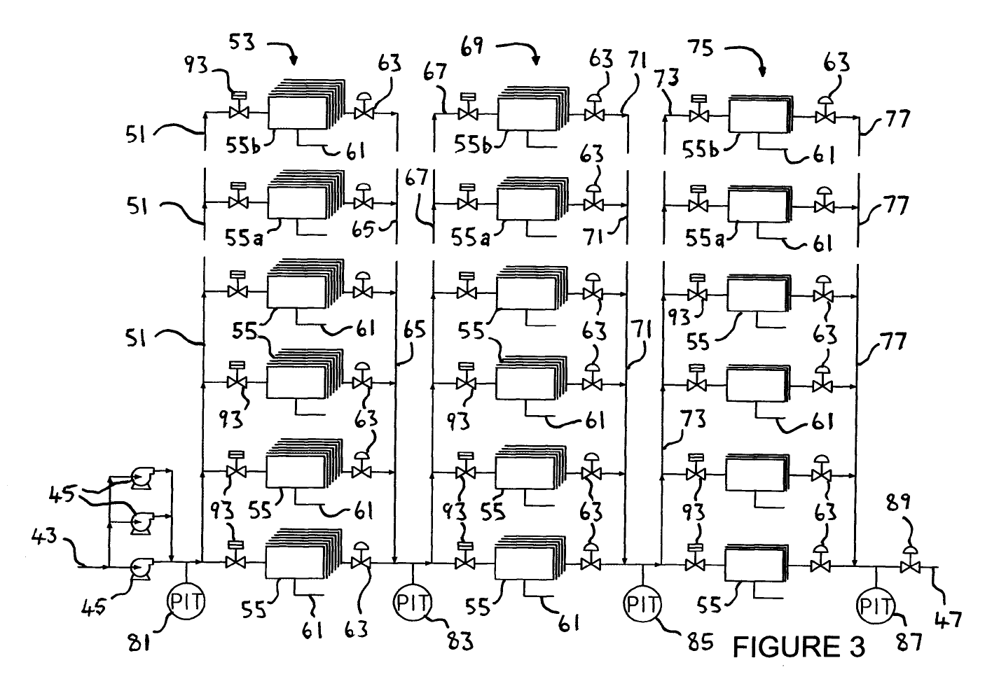

Typically there will be four, five, or six membrane units 55 in each stage 53, 69, 75, in a membrane plant according to the embodiment. Referring to FIG. 3, each stage 53, 69, and 75 is shown with four membrane units 55 connected in circuit. An alternative configuration of the plant will have five membrane units 55 and 55a connected in circuit in each stage, and a further alternative configuration of the plant will have six membrane units 55, 55a and 55b connected in circuit in each stage. While more membrane units than six could be included in each stage, the expense of further instrumentation required does not justify increasing the number of membrane units in each stage beyond six.

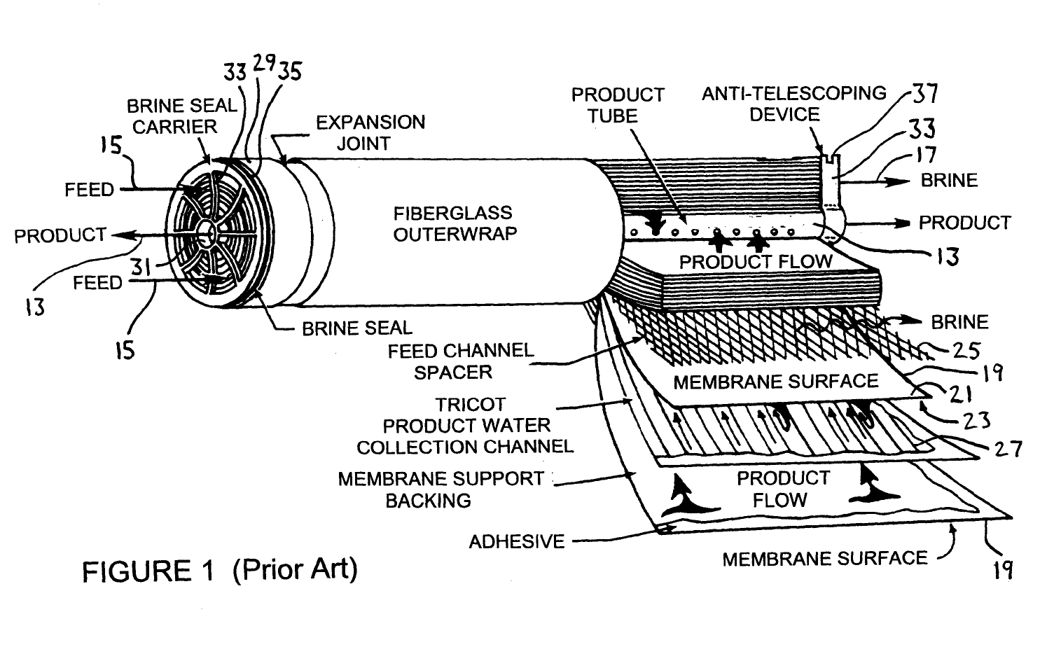

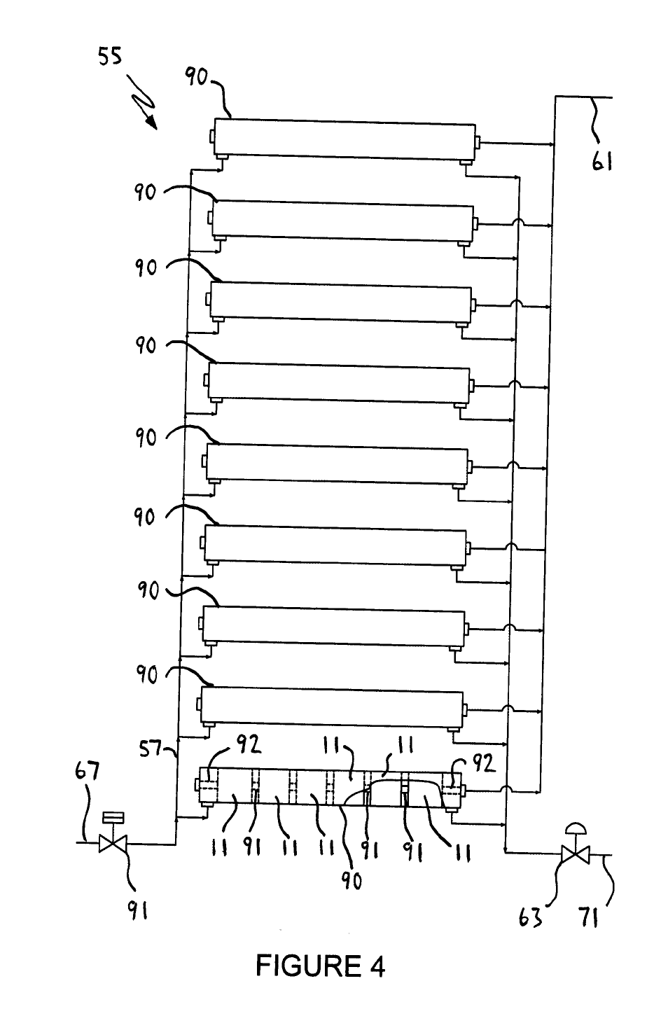

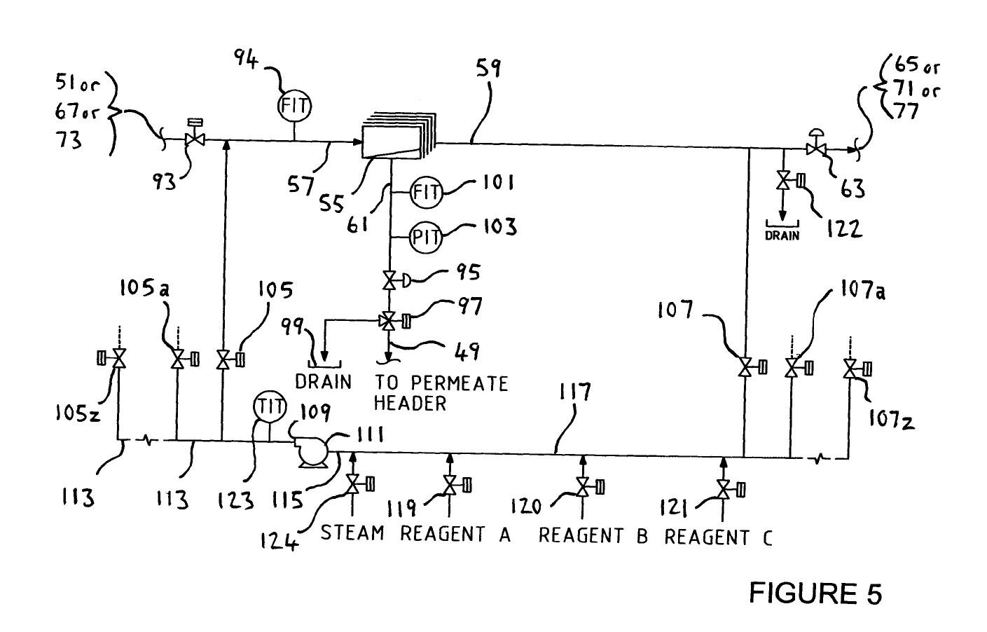

Referring to FIG. 4, each membrane unit 55 comprises a plurality of membrane housings 90 of the type described above, each membrane housing 90 having a series of six spiral wound NF membrane elements 11 of the type illustrated in FIG. 1, but with a membrane with a pore size suited to nanofiltration. The membrane units 55 of the first stage 53 each have thirteen membrane housings 90 arranged in parallel. The membrane units 55 of the second stage 69 each have nine membrane housings 90 arranged in parallel. The membrane units 55 of the third stage 75 each have eight membrane housings 90 arranged in parallel. The number of housings 90 in parallel comprising the membrane units 55 in each stage 53, 69, 75 is determined by the hydraulics of the system. In FIG. 4, a membrane unit 55 of the second stage 69 is shown, having nine membrane housings 90. To show the arrangement of the membrane elements 11 within the membrane housing 90, one of the membrane housings 90 in FIG. 5 is shown partially cut-away to show some of the membrane elements 11, and also with the remaining membrane elements 11 occluded by the membrane housing 90 shown in dashed outline. The membrane elements 11 are joined to each other by cylindrical permeate connectors 91 which telescopingly engage with the centrally located permeate tubes 13 in each adjacent element 11, and are sealed with O-rings (not shown). An end cap adaptor 92 is included at each end of the housing 90 connecting with the end elements 11, to seal the feed/concentrate fluid from the permeate fluid. FIG. 4 shows the membrane housings 90 laid out flat in a row, as they are in the plant. For a compact footprint, the separate membrane units 55 (each comprising a row of membrane housings 90) are arranged in a stacked configuration.

To provide a pore size suited to nanofiltration, the NF membranes have a minimum salt rejection of 97% rejection magnesium sulfate at a standard set of conditions, being 110 psi pressure, 2000 ppm MgSO₄ feed, operating at 15% recovery. The membrane is constructed of a polyamide material and is of 8″ diameter spiral construction, wound around a centrally located permeate tube 13. Each element is 40 inches in length.

The membrane element 11 contains a number of membrane leaves formed by membranes 19 encapsulating a high pressure permeate carrier 27 that are wrapped in a spiral fashion around the centrally located permeate tube 13 and bound in place via an external fiberglass outerwrap. Each membrane leaf consists of a polyamide membrane envelope that has the high pressure permeate carrier 27 enclosed allowing any permeate that passes through the membrane to be transported to the permeate tube. A glue is used to bind and seal the seams of the membranes 19 to form the membrane envelope. Placed between each membrane leaf is the feed spacer 25 that in this embodiment is a woven construction in a diamond pattern and 0.028″ thick. The feed spacer 25 allows the feed solution to flow across the membrane leaf thus providing contact with the membrane surface permitting a portion of the feed to permeate through the membrane 19, into the high pressure permeate carrier 27 from where it flows spiraling inwards to reach the permeate collection tube 13.

Referring to FIG. 5, details are shown of each membrane unit 55, and the cleaning system for the nanofiltration plant. The membrane units 55 in each stage 53 69 or 75 are identical, save for the differing number of membrane housings 90 as discussed above. The number of membrane housings 90 in each membrane unit 55 is determined by the hydraulics in the application in which it is used.

A remotely actuable inlet flow control valve in the form of an inlet isolation valve 93 is provided to isolate the feed inlet 57 of each membrane unit 55 from the common header 51, 67 or 73. The inlet isolation valve 93 is a remotely actuable on/off valve, provided to isolate any membrane unit 55 from its common inlet header 51, 67 or 73. Closing the proportional control valve 63 associated with the membrane unit 55 completes isolation from the feed/concentrate stream. For each membrane unit, a flow transducer 94 measures flow in the feed inlet 57 into the membrane unit 55.

From each membrane unit, a remotely actuable proportional flow control valve 95 controls back pressure on the permeate outlet 61 from the membrane unit 55 and in use is set to provide the correct operating permeate flow through the membranes 19 in the elements 11. A remotely actuable diverter control valve 97 controls discharge of fluid to either the permeate stream 49 when the membrane unit 55 is in circuit and in operation, or to waste drain 99 when the membrane unit 55 is being cleaned. Each permeate outlet has a flow transducer 101 and a pressure transducer 103 for measuring permeate flow and permeate pressure respectively, for feed back to control systems.

Connecting to the feed inlet 57 is the outlet of a cleaning circuit inlet valve 105, and connecting to the feed/concentrate outlet 59 is the inlet of a cleaning circuit outlet valve 107. The cleaning circuit inlet valve 105 connects to the outlet 109 of a cleaning circuit pump 111 via a common inlet cleaning circuit header 113 which also connects to other cleaning circuit inlet valves 105a . . . to 105z. The cleaning circuit outlet valve 107 connects to the inlet 115 of a cleaning circuit pump 111 via a common outlet cleaning circuit header 117 which also connects to other cleaning circuit inlet valves 107a . . . to 107z. Valves 119, 120 and 121 control admittance of cleaning reagents into the cleaning circuit. A valve 122 controls discharge of cleaning fluid from the feed/concentrate outlet 59. A temperature transducer 123 measures reagent temperature for feedback to adjust the temperature of cleaning reagents, as required. This temperature adjustment is achieved by adding steam via a proportional control valve 124.

When cleaning of a membrane unit 55 is required, valves 93 63 and 95 are closed to isolate the membrane unit 55 from its common inlet headers 51, 67, or 73, from its common outlet headers 65 71 or 77, and from the permeate stream 49. The cleaning circuit inlet valve 105 and cleaning circuit outlet valve 107 can be opened and appropriate valves 119, 120, and/or 121 opened to admit cleaning fluid, which is circulated through the membrane unit 55. Valve 97 can be switched to discharge to waste drain 99, while valve 95 is operated to discharge cleaning fluid through the membrane.

When cleaning fluids of different pH to that of the normal process fluid are used, a flushing fluid may be admitted by one of the valves 119, 120, 121 to ensure chemical compatibility and precipitation potential is minimized. A skilled addressee will appreciate which cleaning reagents will be used, depending on the chemistry of the process fluid.

With a plant having four membrane units 55 per stage, when one membrane unit is taken off-line for cleaning, the flow to the three membrane units 55 remaining in circuit in the stage will increase by 33%. With a plant having five membrane units 55 and 55a per stage, when one membrane unit is taken off-line for cleaning, the flow to the four membrane units remaining in circuit in the stage will increase by 25%. With a plant having six membrane units 55, 55a and 55b per stage, when one membrane unit is taken off-line for cleaning, the flow to the five membrane units remaining in circuit in the stage will increase by 20%. The pump capacity is chosen so that the operating parameters of the membrane units are not exceeded when a membrane unit in any one stage is taken off-line for cleaning. With this arrangement, when any membrane unit in any one stage is taken off-line for cleaning, there is generally no necessity to adjust the pumping capacity of the pumps 45, however the plant is monitored to ensure that the maximum flow rate of the membrane housings 90 and elements 11 is not exceeded, and the pumping capacity of the pumps can be altered if extreme circumstances arise, such as unanticipated excessive membrane plugging.

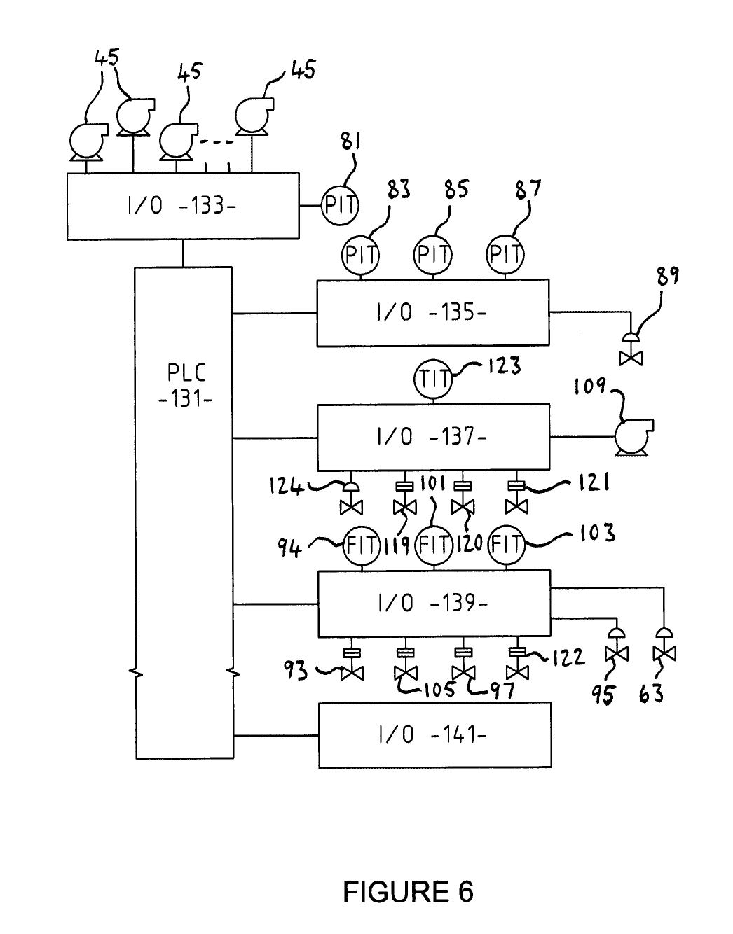

The control system for the membrane plant is shown in FIG. 6, and comprises a processor in the form of a programmable logic controller (PLC) 131 which is interfaced with a plurality of input/output interfaces 133, 135, 137, 139 and 141. The PLC has on-board memory and is interfaced with further memory (not shown) for storage of data and settings. For simplicity of explanation, the input/output interfaces 133, 135, 137, 139 and 141 are split, but in implementation they would typically be unitary, a plurality of inputs, and a plurality of outputs. The input/output interface 133 is connected to control operation of the pumps 45, and receives data from the first pressure transducer 81 and from the flow transducers 94 of the first stage 53, which is used by the PLC 131 to provide a recommendation regarding the number of pumps to operate in order to deliver the required flow to the first stage inlet common header 51. The pumps 45 are started and stopped manually by the plant operators, using feedback communicated by the PLC regarding plant conditions as communicated from the various sensors. In addition to this, the PLC 131 can over-ride operation of the pumps in the event that an emergency condition is detected.

The input/output interface 135 receives pressure data from pressure transducers 83, 85, and 87, and controls operation of the remotely actuable proportional control valve 89. A sensor on the valve 89 feeds back valve position data to the input/output interface 135 so the PLC 131 is cognizant of the degree that the valve is opened.

The input/output interface 137 connects to temperature transducer 123, data from which is used to control admittance of steam via valve 124. The input/output interface 137 also connects to valves 119, 120, and 121 for controlling admitting of cleaning reagent, and to pump 109 for pumping cleaning reagent, when cleaning of a membrane unit is underway.

The input/output interface 139 is specific to a membrane module 55, and there is one such input/output interface 139 for each membrane module 55. The input/output interface 139 connects to flow transducers 94 and 101 for measuring input flow rate and permeate flow rate respectively, and to pressure transducer 103 for measuring permeate pressure. The input/output interface 139 connects to valves 93, 63, and 95, used to control process fluids, and to valves 105, 97, and 122 to control cleaning fluids. Data from the flow transducers 94 and 101, and pressure transducer 103, obtained from all of the input/output interfaces 139 connected to the PLC 131 is used along with data from the pressure transducer 81 for operation of the pumps 45, and for plant diagnostics, and the determination of clean-now manually controlled cleaning of any membrane modules.

The input/output interface 141 includes connections to displays, keyboards and control switches (for brevity and clarity, all not illustrated) for use by personnel operating the plant.

In operation of the plant, pressure is measured in the feed stream 43 to the NF plant on the feed pump 45 suction (pressure transducer not shown) and on the discharge by pressure transducer 81. Pressure is also measured on the feed to subsequent stages and on the permeate of each stage and train where multiple trains are employed by pressure transducers 83 and 85. Pressure is also measured by pressure transducer 87 finally prior to remotely actuable proportional control valve 89 where the retentate (feed/concentrate) is discharged. In circumstances where there is high scaling potential, multiple membrane units 55 controlled by valves 93 and 63 are employed in a duty/duty fashion. Thus, with five membrane units 55 in any stage, if one membrane unit is taken off-line for cleaning, this will result in an increase in flow of 25% in the feed to the membrane units that remain on line. While the membrane units 55 can be operated in a duty/standby fashion, this is inefficient and defeats the purpose of the common header arrangement of the invention.

Flow is measured at the feed to each membrane unit 55 and also on the permeate of each membrane unit 55.

Feed from a feed tank is transferred to the NF plant via high pressure feed pumps 45 capable of delivering the desired flow rate at up to the maximum pressure rating of the membrane units 55. The feed pump/s are protected by a pump strainer (not shown) and a high pressure alarm which shutdown the pumps upon activation.

The high pressure pump operates to a target pressure that may be manipulated depending on operating conditions but is usually operated at 400 psi. The pump has a maximum pressure shutdown that relates to the maximum working pressure of the NF membrane units 55 of 600 psi. The feed pressure is controlled via the high pressure pump(s) and influenced by the control valve 89 at the pressure required to achieve the target recovery. The target recovery for the NF plant is between 30% and 60%, typically 45% where 45% of the feed that is filtered reports to the NF permeate stream 49.

High pressure water enters NF membrane stage one 53 and progresses through to stage three 75, and a portion of the feed solution permeates through each NF membrane unit 55 in a controlled fashion at a desired flux rate which may be anywhere up to 25 gfd (gallons per square ft per day). The desired flux rate is achieved by manipulating the flux control valves 95 as the target permeate flow is measured by individual stage permeate flow meters 101. Flux rates may be in the range of 4 to 25 gfd. Typically, stage one flux rate would be set to about 9.8 gfd, stage 2 flux rate would be set to about 6.1 gfd and stage 3 flux rate would be set to about 5.3 gfd The remaining feed is bled from the system via the control valve 89 at the desired plant recovery.

Valves allow the membrane units 55 to be isolated for maintenance, and valves 99 and 122 also allow for the interrogation of system performance. To manage the different operating conditions across the NF plant a monitoring system and membrane cleaning regime is provided. Some of the features of the scale cleaning management system on the NF plant include individual membrane unit monitoring for flow and pressure as well as an ability to take offline portions of the plant (unit) for cleaning, whilst leaving the remaining plant fully operational. The arrangement of common headers 51, 65, 67, 71, 73, and 77 allow individual membrane units 55 to be taken offline and cleaned without affecting upstream or downstream membrane unit operation as would be the case if membrane units were arranged serially. Even though both flow and pressure are monitored, the key criteria for scale management is time based cleaning, i.e. performing the cleaning at predetermined durations rather than allowing for the onset of scale formation which in turn impacts both flow and operating pressure.

The NF plant is maintained via a multifaceted cleaning system which includes the combination of flushing and chemical cleaning, or clean in place (CIP) sequences using multiple cleaning solutions. These sequences are timed and may also be operator initiated. Both methods of cleaning involve a sequence of valve openings and closures in a predetermined manner to enable cleaning solutions to enter the plant.

Chemical cleaning requires a membrane unit 55 to be taken off line and isolated from the main process stream, as has been described above. When assembled in multiple trains the plant is configured such that a portion of the plant can be taken offline for chemical cleaning. A portion of the 1^{st} stage, a portion of the 2^{nd} stage and 3^{rd} stage can be taken off line independently. Whilst off line, a cleaning solution consisting of an acidic solution and an alkaline solution may circulated through the membrane at intervals effectively dissolving and dispersing any accumulated solids and chemical fouling. The cycle duration of the chemical clean is about an hour and it occurs about once every one to four days.

The nanofiltration plant described above has been designed using “common headers”. In the common header design of the invention, the feed exiting stage one 53 membrane units 55 as concentrate is recombined before feeding into stage two 69. In this manner, concentrate from one membranes unit 55 in stage one 53 will end up in any stage two membrane unit, and not just a particular membrane unit or units. The advantages of the common header design means that all stages in all trains are in operation, except for when they are undergoing cleaning in-place. A clean in-place can be performed on any individual membrane unit 55 of any individual train. In a non-common header design, if any stage of a train is cleaned in place, the other stages in that train cannot be used for production. Thus, in a non-common header design, for a 5 train, 3 stage design, 20% of plant capacity is lost during cleaning in place.

The frequency of cleaning is typically significantly higher for the last stage 75 in a membrane plant, as it sees the most concentrated feed. A typical frequency ratio of cleaning in-place for a three stage plant would be stage three 75 to have triple the frequency compared to stage one and stage two 69 would have double the frequency compared to stage one 53.

As the design of a plant is tapered for hydraulic reasons, the last stage 75 of the plant also has the lowest production rate of permeate, typically in a three stage plant the first stage 53 produces 50%, the second stage 69 produces 30% and the third stage 75 produces 20% of the permeate.

Thus, in a non-common header design, the frequency of the last stage 75 cleaning in-place, which only accounts for 4% of permeate per train, dictates when 20% of plant capacity needs to be off-line for cleaning. Factor in the additional frequency requirement of cleaning in-place for stage three 75 and this results in additional unnecessary downtime for stages one and two. A common header design overcomes this limitation by allowing a single membrane unit 55 of any stage to be cleaned individually.

There are hydraulic implications to the number of trains required to utilize common headers, as the flow that would normally pass thru a single unit must now pass thru the remaining on-line units of that stage. A membrane has a minimum and maximum feed rate and the design must ensure that these limits are not exceeded during the CIP, or that appropriate control measures are used to ensure critical parameters are not exceeded during unequal unit operation per stage.

By using common headers, greater equipment utilization is obtained, as only the units requiring cleaning are taken off-line. This also improves membrane life, as membranes are not prematurely cleaned, thus the resultant pH shock that can occur with cleaning chemicals and pressure changes are reduced. Membrane inventory is also reduced as the greater equipment utilization reduces the number of membranes required to produce a set production rate.

Additional valving and piping is required to implement common headers as each unit needs to be able to be isolated individually. Also, additional instrumentation is required to monitor each unit. An economic appraisal is required to justify if the additional cost to implement common headers over a typical train approach for any installation. The higher the frequency of cleaning and the shorter the anticipated membrane life, the greater the advantage of common headers.

During normal operation of a common header plant with all trains and stages in service, the feed and concentrate valves are open, along with the permeate valves.

As the individual units are controlled to a target flux rate, the permeate valve 95 modulates to the target flux rate. The target flux rate is calculated from the desired recovery for a membrane unit 55. The feed pressure to the plant is set by the plant operator and is adjusted to ensure the permeate control valve 95 is not fully open.

The concentrate control valve 63 on each unit 55 is used to balance the feed flow as measured by the flow transducers 94 within each membrane unit. If otherwise left unregulated, a minor blockage in one unit will decrease flow to that unit 55 while increasing flow to the other units 55 in that stage. A lower flow in a unit 55 will promote scaling and further reduce flows, which promotes more scaling thus even lower flows, hence a downhill spiral occurs. Flow balancing via the unit concentrate valves 63 applies backpressure to the non-scaled units to balance pressure drop across all units in a stage equally. The pressure drop across a stage is monitored and will shut down the plant to protect the membranes if exceeded.

The feed flow is controlled by the flow control valve 63 to a target rate based on a calculation from the stage target recovery. The target recovery is based on the scaling potential of the feed liquor at normal temperature. As this characteristic changes with feed temperature, the target recovery is reduced with lower feed temperature.

Membrane fouling typically occurs through one of two mechanisms, membrane resistance which is resistance to flow through the membrane and membrane plugging which is resistance to flow across the membrane through the feed/concentrate path. Membrane fouling is usually quantified by the membrane resistance calculation, as membrane resistance is usually the dominant form of fouling but membrane plugging can become dominant in certain situations such as reduced solubility due to feed temperature drop. Membrane resistance calculation is based on the feed flow, feed pressure, permeate flow, permeate pressure, feed temperature, feed viscosity and membrane area. Membrane resistance is closely monitored and this data forms the basis of the CIP schedule. Any out of schedule clean can also be initiated on signs of membrane fouling.

Typically the determination for cleaning schedule or clean now is determined as follows. The required number of membrane units 55 are operated in parallel at a feed pressure determined by the number of pumps 45 in operation. The feed/concentrate control valves 63 are set so that the flow as measured by the flow transducers 94 is balanced. The feed/concentrate control valves 63 are operated within the range of no greater than 50% restriction, and up to 100% fully open. When any one feed/concentrate control valve 63 is fully open and unable to control a reduction of flow rate through its associated membrane unit 55 as measured by its flow transducer 94, in the order of around 20% compared with the others, the membrane unit should be cleaned. While this variation may approach 30% before cleaning should take place, the absolute maximum variation should never exceed 50%.

The permeate control valves 95 are operated to achieve a desired flux rate, as can be measured with the flow transducers 101. If the valves reach a condition in operation of 100% open and the flux rate cannot be maintained to 80% of the desired flux rate, the membrane unit 55 with which the valve 95 and flow transducer 101 is associated should be subjected to cleaning. Alternatively, the number of pumps 45 in operation could be increased in an attempt to maintain the desired flux rate, however the maximum plant pressure should not be exceeded. Increasing the pressure in this manner will not obviate the need to clean the membrane unit concerned, and will likely increase the fouling of the membrane unit, as measured by the membrane resistance.

The cleaning in-place system is automated based on a time schedule. Cleaning in-place can be performed outside of the time schedule via a “Clean in-place now” button. The cleaning in-place schedule can easily be updated with different cleaning frequencies if required.

When a clean in-place is initiated, feed pump pressure is briefly lowered while the feed and concentrate valves are closed, isolating the membrane unit 55 to undergo cleaning. The control system adjusts the parameters of the units 55 remaining on-line to accommodate the altered flow pattern. The unit 55 under the clean in-place regime is purged of feed fluid via the CIP pump 111 forcing fluid out via the discharge drain valve 122.

Once purged of feed fluid, the cleaning fluid is heated and recirculated within the unit for the target time and temperature. Additional cleans and purges of low, high or neutral pH are undertaken, depending on the type of clean scheduled.

When the CIP sequence is complete, the final step is to charge the unit with low pH fluid ready to be brought back on-line. It is critical that the unit is purged of air prior to coming on-line as the hydraulic shock of opening the feed valves to a unit with air can cause significant membrane damage.

Bringing a unit back on-line is consists of briefly lowering the feed pressure while the feed, concentrate and permeate valves are opened. Once on-line, the feed pump ramps back up to pressure and all units modulate their parameters to reach set point.

While the embodiment of the present invention has been described with reference to a nanofiltration plant, it also has application in a reverse osmosis plant, or any other filtration plant where there are large numbers of modules employed in parallel and having more than one stage. It should be appreciated that changes may be made to the embodiment described herein, including adapting the filter elements to filtration of particles, without departing from the spirit and scope of the invention.

1. A membrane treatment plant having at least two stages arranged serially, each stage comprising at least four membrane units, each membrane unit having an inlet, a feed/concentrate outlet and a permeate outlet;
each of said stages having a common inlet header and a common outlet header, with the common outlet header of an upstream stage connecting to the common inlet header of an immediately downstream stage;
each membrane unit having an inlet flow control valve connecting between said inlet and said common inlet header, and an outlet flow control valve connecting between said feed/concentrate outlet and said common outlet header, said inlet flow control valve and said outlet flow control valve being operable to isolate said membrane unit from said common inlet header and said common outlet header to allow cleaning of said membrane unit to take place without disrupting operation of the remaining membrane treatment plant.

2. A membrane treatment plant as claimed in claim 1 wherein there are up to six membrane units in each stage.

3. A membrane treatment plant as claimed in claim 1 wherein there are five membrane units in each stage.

4. A membrane treatment plant as claimed in claim 1 wherein each said membrane unit has a cleaning circuit inlet valve connecting to said inlet and a cleaning circuit outlet valve connecting to said feed/concentrate outlet, to allow in-circuit cleaning of said membrane unit to take place when said membrane unit is isolated from said common inlet header and said common outlet header.

5. A membrane treatment plant as claimed in claim 4 wherein said membrane treatment plant has a cleaning inlet common header and a cleaning outlet common header connecting to the cleaning circuit inlet valve and cleaning circuit outlet valve of each membrane unit in the membrane treatment plant, and said cleaning inlet common header and said cleaning outlet common header are connected to a recirculating pump to supply cleaning fluid and rinse fluid to said membrane unit.

6. A membrane treatment plant as claimed in claim 4 wherein each said stage in said membrane treatment plant has a cleaning inlet common header and a cleaning outlet common header connecting to the cleaning circuit inlet valve and cleaning circuit outlet valve of each membrane unit in the stage and each said cleaning inlet common header and said cleaning outlet common header of each stage are connected to a recirculating pump to supply cleaning fluid and rinse fluid to said membrane unit.

7. A membrane treatment plant as claimed in claim 1 wherein each said membrane unit has a drain valve connected to said feed/concentrate outlet.

8. A membrane treatment plant as claimed in claim 1 wherein each said membrane unit has a permeate outlet flow control valve connected to said permeate outlet.

9. A membrane treatment plant as claimed in claim 1 wherein said inlet flow control valve is a stop valve.

10. A membrane treatment plant as claimed in claim 1 wherein said outlet flow control valve is a proportional valve.

11. A membrane treatment plant as claimed in claim 8 wherein said permeate outlet flow control valve is a proportional valve.

12. A membrane treatment plant as claimed in claim 1 wherein said inlet of each said membrane unit has associated therewith an inlet flow measuring device for measuring volumetric flow into said inlet.

13. A membrane treatment plant as claimed in claim 1 wherein the permeate outlet of each said membrane unit has associated therewith a permeate flow measuring device for measuring volumetric flow from said permeate outlet.

14. A membrane treatment plant as claimed in claim 11 wherein the permeate outlet of each said membrane unit has associated therewith a pressure measuring device for measuring pressure at said permeate outlet, before said permeate outlet control valve.

15. A membrane treatment plant as claimed in claim 1 wherein said common inlet header has a pressure measuring device associated therewith, to measure fluid pressure in said common inlet header.

16. A membrane treatment plant as claimed in claim 1 wherein said common outlet header has a pressure measuring device associated therewith, to measure fluid pressure in said common outlet header.

17. A membrane treatment plant having at least two stages arranged serially, each stage comprising at least four membrane units, each membrane unit having an inlet, a feed/concentrate outlet and a permeate outlet;
each of said stages having a common inlet header and a common outlet header, with the common outlet header of an upstream stage connecting to the common inlet header of an immediately downstream stage;
each membrane unit having an inlet flow control valve connecting between said inlet and said common inlet header, and an outlet flow control valve connecting between said outlet and said common outlet header, said inlet flow control valve and said outlet flow control valve being operable to isolate said membrane unit from said common inlet header and said common outlet header to allow cleaning of said membrane unit to take place without disrupting operation of the remaining membrane treatment plant;
each said membrane unit having a permeate outlet flow control valve connected to said permeate outlet, said permeate outlet flow control valve being a proportional valve,
said inlet of each said membrane unit having associated therewith an inlet flow measuring device for measuring volumetric flow into said inlet, and the permeate outlet of each said membrane unit having associated therewith a permeate flow measuring device for measuring volumetric flow from said permeate outlet.

18. A membrane treatment plant having at least two stages arranged serially, each stage comprising at least four membrane units, each membrane unit having an inlet, a feed/concentrate outlet and a permeate outlet;
each of said stages having a common inlet header and a common outlet header, with the common outlet header of an upstream stage connecting to the common inlet header of an immediately downstream stage;
each membrane unit having an inlet flow control valve connecting between said inlet and said common inlet header, and an outlet flow control valve connecting between said outlet and said common outlet header, said outlet flow control valve being a proportional valve, and said inlet flow control valve and said outlet flow control valve being operable to isolate said membrane unit from said common inlet header and said common outlet header to allow cleaning of said membrane unit to take place without disrupting operation of the remaining membrane treatment plant;
each said membrane unit having a permeate outlet flow control valve connected to said permeate outlet, said permeate outlet flow control valve being a proportional valve,
said inlet of each said membrane unit having associated therewith an inlet flow measuring device for measuring volumetric flow into said inlet, and the permeate outlet of each said membrane unit having associated therewith a permeate flow measuring device for measuring volumetric flow from said permeate outlet.

19. A control system for controlling operation of a membrane treatment plant as claimed in claim 4, said control system controlling operation of inlet flow control valves and outlet flow control valves of a plurality of membrane units to take at least one membrane unit in any stage off-line for cleaning, and controlling cleaning circuit inlet valves and cleaning circuit outlet valves associated with the targeted said at least one membrane unit to feed cleaning solution to the targeted said at least one membrane unit.

20. A control system as claimed in claim 19 wherein said control system controls operation of inlet flow control valves and outlet flow control valves of said plurality of membrane units to take at least one membrane unit in any stage off-line on a rotational basis for cleaning.

21. A control system as claimed in claim 19 wherein said control system incorporates a manually initiated “clean now” function for any one or more of said plurality of membrane units to take at least one membrane unit in any stage off-line for cleaning.

22. A control system for controlling operation of a membrane treatment plant as claimed in claim 17, said control system controlling operation of inlet flow control valves and outlet flow control valves of a plurality of membrane units to take at least one membrane unit in any stage off-line for cleaning, and controlling cleaning circuit inlet valves and cleaning circuit outlet valves associated with the targeted said at least one membrane unit to feed cleaning solution to the targeted said at least one membrane unit, wherein said control system monitors membrane resistance, by measuring flux rate for each membrane unit and storing current flux rate values, controlling said permeate outlet flow control valve for each said membrane unit to achieve a desired flux rate, where a high membrane resistance indication is given if said permeate outlet flow control valve is from 85% to 90% open to fully open and the actual flux rate falls below 90% of the desired flux rate.

23. A control system as claimed in claim 22 wherein the control system adjusts the pressure of the inlet feed by controlling operation of pumps, to assist in meeting the desired flux rate.

24. A control system for controlling operation of a membrane treatment plant as claimed in claim 18, said control system controlling operation of inlet flow control valves and outlet flow control valves of a plurality of membrane units to take at least one membrane unit in any stage off-line for cleaning, and controlling cleaning circuit inlet valves and cleaning circuit outlet valves associated with the targeted said at least one membrane unit to feed cleaning solution to the targeted said at least one membrane unit, wherein said control system monitors flow balancing of said membrane units by measuring individual feed flow to each inlet of each membrane unit in each stage of membrane units, storing current feed flow values separately for each stage, controlling each outlet flow control valve associated with each said membrane unit to balance feed flow to each inlet of each membrane unit in each stage, and issuing a high membrane plugging indication for a membrane unit if any of its outlet flow control valves is opened to 90% and the inlet flow value for that membrane unit drops to 20% below the inlet flow value for other membrane units in the same stage.
